(19) United States
(12) Patent Application Publication
(10) Pub. No.: US 2004/0001183 A1
(43) Pub. Date: Jan. 1, 2004

(54) Image display apparatus

(76) Inventors: Nicholas Richard Coates, Crowborough (GB); Roger Brian Huxford, Burgess Hill (GB)

Correspondence Address: IANDIORIO & TESKA, INTELLECTUAL PROPERTY LAW ATTORNEYS, 260 BEAR HILL ROAD, WALTHAM, MA, 02451-1018, US

(21) Appl. No.: 10/394,829

(22) Filed: Mar. 21, 2003

(30) Foreign Application Priority Data
Mar. 22, 2002 (GB) 0206869.0

(51) Int. Cl. G03B 21/26

(52) U.S. Cl. 353/30

(57) ABSTRACT

Image display apparatus (26) comprising a display panel (28), a screen (30), and image relay apparatus (2), the optical relay apparatus (2) comprising at least one aspherical polymer lens (8, 10, 12,14) and at least one spherical glass lens (4, 6), the said lenses being such that an image is able to be relayed from the display panel to the screen with a predetermined distortion, the optical relay apparatus (2) being such that it has a final aspherical polymer lens (14) which is the said aspherical polymer lens (8, 10, 12, 14) or one of the said aspherical polymer lenses, the final aspherical polymer lens (14) has a first depression (16) on a first side (18) and a second and larger depression (20) on a second side (22), the first side (18) being nearer to the display panel (28) than the second side (22), and the final aspherical polymer lens (14) directs light towards the screen (30) such that the direction of light rays complements the operation of an eyepiece used to view the screen (30).

This invention relates to image display apparatus and more especially, this invention relates to image display apparatus including optical relay apparatus.

In one non-limiting embodiment of the present invention, there is provided image display apparatus comprising a display panel, a screen, and optical relay apparatus, the optical relay apparatus comprising at least one aspherical polymer lens and at least one spherical glass lens, the said lenses being such that an image is able to be relayed from the display panel to the screen with a predetermined distortion, the optical relay apparatus being such that it has a final aspherical polymer lens which is the said aspherical polymer lens or one of the said aspherical polymer lenses, the final aspherical polymer lens has a first depression on a first side and a second and larger depression on a second side, the first side being nearer to the display panel than the second side, and the final aspherical polymer lens directs light towards the screen such that the direction of light rays complements the operation of an eyepiece used to view the screen.

The predetermined distortion is preferably a barrel distortion The image may be relayed from the display panel to the screen with other types of distortion if desired.

Preferably, the optical relay apparatus is one in which there are four of the aspherical polymer lenses, and two of the spherical glass lenses.

Preferably, the second side of the final aspherical polymer lens has a bevelled edge.

The image display apparatus may be one in which the optical relay apparatus is such that is has a first spherical glass lens which is the said spherical glass lens or one of the said spherical glass lenses.

The display panel may be a reflective display panel. Alternatively, the display panel may be a transmissive display panel.

A presently preferred display panel is a ferro-electric liquid crystal on silicon display panel. Other types of display panel that may be employed are a liquid crystal on silicon display panel, a liquid crystal display panel, and a digital micromirror device display panel.

The screen may be a rear projection screen or any other suitable and appropriate type of screen.

The image display apparatus may be in the form of a head mounted display. The image display apparatus may take other forms if desired so that, for example, the image display apparatus may be a periscope simulator.

Embodiments of the invention will now be described solely by way of example and with reference to the accompanying drawings in which:

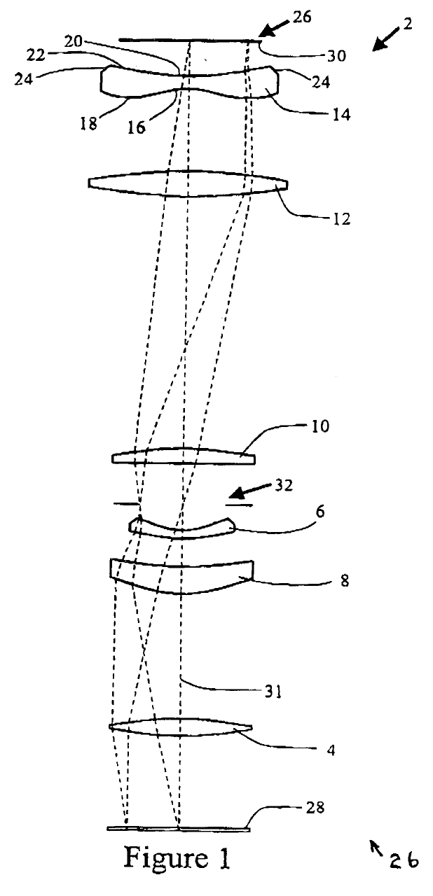

FIG. 1 shows image display apparatus including optical relay apparatus comprising a plurality of spherical glass lenses and aspherical polymer lenses; and

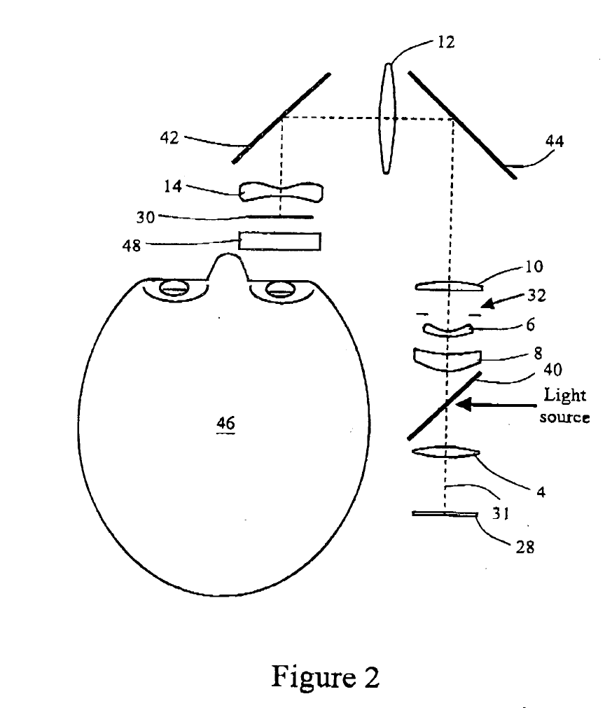

FIG. 2 illustrates how mirrors can be used to fold the optical relay apparatus to a desired shape.

Referring to FIG. 1, there is shown optical relay apparatus 2 comprising two spherical glass lenses 4, 6 and four aspherical polymer lenses 8, 10, 12, 14. The combination of the lenses 4, 6, 8, 10, 12, 14 is a hybrid design. In this hybrid design, the design of some of the lenses is radical, and this applies especially to the design of the aspherical polymer lens 14.

As can be seen from FIG. 1, the final lens in the hybrid design is one of the aspherical polymer lenses, namely the aspherical polymer lens 14. This aspherical polymer lens 14 constitutes a final field lens. The asphercal polymer lens 14 has a first depression 16 on a first side 18, and a second and larger depression 20 on a second side 22. As also shown in FIG. 1, the second side 22 of the aspherical polymer lens 14 has a beveled edge 24.

The first lens in the combination of lenses shown in FIG. 1 is the lens 4 which is one of the spherical glass lenses.

The optical relay apparatus 2 so far described forms part of image display apparatus 26 including a display panel 28. The optical relay apparatus 2 is such that an image is able to be relayed from the display panel 28 with a predetermined distortion. This predetermined distortion is a barrel distortion. The display panel 28 is a ferro-electric liquid crystal on silicon display panel. Such a display panel 28 is preferred as it has a desired resolution of at least SXGA (1200×1024), and the display panel 28 can be switched fast enough to allow field sequential colour illumination of the display panel 28 to be used to provide a colour image from a single panel.

The image display apparatus 26 also includes a screen 30.

The entire image display apparatus 26 shown in FIG. 1 may form part of image display apparatus in the form of a head mounted display. The head mounted display is such that the image is able to be distorted to a desired shape when relayed to the screen 30. The predetermined barrel distortion is able to enhance the performance of an eyepiece needed to view the screen 30.

The optical relay apparatus 2 is designed to introduce the barrel distortion into the image such that it complements a pin cushion distortion of the eyepiece. The spacing of the lenses 4, 6, 8, 10, 12, 14 in the optical relay apparatus 2 allows for the inclusion of fold mirrors. The inclusion of fold mirrors enables the optical relay apparatus 2 to be folded around a person's head. FIG. 1 shows the layout of the optical components in a linear arrangement. The direction of the rays hitting the screen 30 is complementary to the eyepiece, the screen 30 functioning to spread the light, necessary to achieve a large eye-pupil, but not redirecting it. The maximum use of polymer aspherical lenses has the benefit of reducing weight since polymers are less dense than glass. Also, the use of aspheric geometry enables fewer lenses to be used. Reducing the number of lenses also reduces light and contrast loss in the system through surface reflections

In addition to relaying the image generated by the display panel 28 to the screen 30, the optical relay apparatus 2 fully compensates for distortion of the eyepiece, approximately 27%, and directs the rays hitting the screen 30 so that they are complementary to the required input direction of the eyepiece. Furthermore, the field lens 4 ensures that the principal rays are telecentric when leaving the display panel 28. This feature is necessary to achieve an even illumination across the field of view. In order to meet all of these requirements, known conventional optical relay apparatus using spherical surfaces only would require up to two times the number of optical components and would, as a result, be much heavier and much less compact. The combination of the spherical glass lenses and the aspherical polymer lenses makes it possible to achieve all of the above conditions, while still obtaining a high polychromic resolution at the magnified image of greater than 50 LPM over 95% of the field of view.

An all polymer design with aspheric surfaces is, feasible for the correction of monochromatic aberrations, but the limited range of high dispersion flint equivalent polymers makes it difficult to achieve good chromatic correction and therefore a good polychromatic resolution without additional lens elements. The additional polymer lenses, although individually lightweight in comparison to glass, also tend to have a steeper surface curvature to make up for the smaller dispersion differential of crown and flint polymer materials available. Thus any potential weight saving is lost. In addition, the extra lens surfaces reduce the light transmission and contrast even though anti-reflective coatings are used.

In FIG. 1, the function of relaying the image from the display panel 28 to the screen 30 is primarily achieved with the central triplet formed by the lenses 6, 8, 10, the display panel 28 in this case being a reflective display panel. The outer surfaces of the lenses 8 and 10 have aspherical surfaces to correct the spherical aberration. The lens 6 is a high index, high dispersion, lightweight glass (Nd=1.80518, Vd=25.36, p=3.37 g/cc) which together with the low dispersion glass lens 4 (Nd=1.48749, Vd=70.41) significantly reduces the chromatic aberration of the relay system. In the above mentioned physical characteristics, Nd is the index of refraction for the helium d line, and Vd is the Abbe V-number or reciprocal relative dispersion.

Irrespective of whether the display panel 28 is being used in transmissive or reflective mode, the principal rays 31 need to be parallel to the optical axis i.e. telecentric, in order to achieve an even illumination across the field of view. The lens 4 performs the telecentric function and acts as a field lens to direct the principal rays to the centre of an aperture stop 32.

In order to compensate for the eyepiece distortion, the optical relay apparatus 2 provides approximately 27% barrel distortion, In other words, the image at the screen 30 is compressed towards the edge of the field of view. This compensation is primarily achieved by the highly aspheric first surface of the lens 14, but it is also assisted by the lens 12 which gives the initial direction of the off-axis ray bundles towards the lens 14. The lens 12 has an aspheric surface to assist the distortion compensation. Without aspheric surfaces, especially for the lens 14, it would be necessary to use three or four spherical surfaced lenses in order to achieve the same level of distortion compensation. This would not only increase the weight of the entire apparatus, but it would also increase the moment of inertia as the optics would be further away from the person's head when the optical relay apparatus forms part of a head mounted display. The last surface of the lens 14 is spherical but with the above mentioned recess 20 which is a deep concave shape as shown. This deep concave shape corrects the field curvature of the remainder of the relay lens, and also directs the rays to the required input direction of the eyepiece.

Referring now to FIG. 2, similar parts as in FIG. 1 have been given the same reference numerals for ease of comparison and understanding. In FIG. 2, there is shown how mirrors 42, 44 can be used to fold the relay optics around a desired shape. As shown in FIG. 2, the relay optics are used in a head mounted display and so they are folded around a person's head 46. A semi-transparent mirror 40 is used to introduce light onto a reflective display panel 28. The image produced on the screen 30 is viewed using an eyepiece 48. FIG. 2 shows an arrangement for one eye only. A similar arrangement would be needed for the other eye.

It is to be appreciated that the embodiments of the invention described above with reference to the accompanying drawings have been given by way of example only and that modifications may be effected. Thus, FIG. 1 illustrates how the combination of aspherical polymer lenses and spherical glass lenses can be used to introduce distortion into an image. This distortion can be different from that shown in FIG. 1 and the distortion can generally be varied to suit different applications, If desired, a different type of display panel 28 can be employed so that, for example, the display panel 28 may be a liquid crystal on silicon display panel, a liquid crystal display panel, or a digital micromirror device display panel.

1. Image display apparatus comprising a display panel, a screen, and optical relay apparatus, the optical relay apparatus comprising at least one aspherical polymer lens and at least one spherical glass lens, the said lenses being such that an image is able to be relayed from the display panel to the screen with a predetermined distortion, the optical relay apparatus being such that it has a final aspherical polymer lens which is the said aspherical polymer lens or one of the said aspherical polymer lenses, the final aspherical polymer lens has a first depression on a first side and a second and larger depression on a second side, the first side being nearer to the display panel than the second side, and the final aspherical polymer lens directs light towards the screen such that the direction of light rays complements the operation of an eyepiece used to view the screen.

2. Image display apparatus according to claim 1 in which there are four of the aspherical polymer lenses, and two of the spherical glass lenses.

3. Image display apparatus according to claim 1 in which the second side of the final aspherical polymer lens has a bevelled edge.

4. Image display apparatus to claim 1 in which the optical relay apparatus is such that it has a spherical glass lens which is the said spherical glass lens or one of the said spherical glass lenses.

5. Image display apparatus according for claim 1 in which the display panel is a reflective display panel.

6. Image display apparatus according to claim 1 in which the display panel is a transmissive display panel.

7. Image display apparatus according to claim 1 in which the display panel is ferroelectric liquid crystal on silicon display panel

8. Image display apparatus according to claim 1 in which the display panel is a liquid crystal on silicone display panel, a liquid crystal display panel, or a digital micromirror device display panel.

9. Image display apparatus according to claim 1 in which the screen is a rear projection screen.

10. Image display apparatus according to claim 1 and in the form of a head mounted display.
